(19) United States
(12) Patent Application Publication
(10) Pub. No.: US 2007/0111078 A1
(43) Pub. Date: May 17, 2007

(54) FUEL CELL BIPOLAR PLATE

(75) Inventor: Fumio TANNO, Okazaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 11/557,701

(22) Filed: Nov. 8, 2006

(30) Foreign Application Priority Data
Nov. 11, 2005 (JP) 2005-327627

(51) Int. Cl. H01M 8/02; B32B 9/00

(52) U.S. Cl. 429/34; 428/408; 429/38

(57) ABSTRACT

A fuel cell bipolar plate obtained by molding a composition which includes specific amounts of a porous artificial graphite material, a thermoset resin and an internal release agent has dramatically improved mechanical characteristics, including flexural strength and flexural strain. Even when given a thin-walled construction, the bipolar plate has a sufficient strength and excellent flexibility.

### CROSS-REFERENCE TO RELATED APPLICATION

This non-provisional application claims priority under 35 U.S.C. §119(a) on Patent Application No. 2005-327627 filed in Japan on Nov. 11, 2005, the entire contents of which are hereby incorporated by reference.

### BACKGROUND OF THE INVENTION

1. Field of the Invention

The present invention relates to a fuel cell bipolar plate. More specifically, it relates to a fuel cell bipolar plate which exhibits sufficient strength even given a thin-walled construction.

2. Prior Art

Fuel cells are devices which, when supplied with a fuel such as hydrogen and with atmospheric oxygen, cause the fuel and oxygen to react electrochemically, producing water and thus directly generating electricity. Because fuel cells are capable of achieving a high fuel-to-energy conversion efficiency and are environmentally adaptable, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like bipolar plates with ribs on either side thereof that define a plurality of channels for the flow of gases such as hydrogen and oxygen. Disposed between the pair of bipolar plates in the unit cell are a solid polymer electrolyte membrane and gas diffusing electrodes made of carbon paper.

One role of the fuel cell bipolar plates is to confer each unit cell with electrical conductivity. In addition, the bipolar plates provide flow channels for the supply of fuel and air (oxygen) to the unit cells and also serve as boundary walls separating the unit cells. Characteristics required of the bipolar plates thus include a high electrical conductivity, a high gas impermeability, electrochemical stability and hydrophilicity.

However, there has been a growing demand in recent years for smaller and thinner designs in a variety of manufactured products. In the case of solid polymer fuel cells, a smaller, more compact volume is desired for use in vehicles as an on-board, alternative power supply to the internal combustion engine.

Techniques for obtaining thin, high-strength fuel cell bipolar plates include (1) the admixture of short carbon fibers or short metal fibers in a material for molding bipolar plates (JP-A 2000-182630), and (2) orienting a fibrous base material at a fixed angle to the thickness direction of the bipolar plate so as to ensure the strength of the thin-walled portions of the bipolar plate (JP-A 2001-189160).

However, bipolar plates obtained by above method (1) are manufactured by molding a mixture of graphite powder, thermoset resins such as phenolic resin and epoxy resin, and carbon fibers. Hence, the resulting bipolar plate has an improved strength, but it also has a much higher modulus of elasticity, as a result of which it has a tendency to break when given a thin-walled construction.

As with method (1) above, bipolar plates obtained by above method (2) are manufactured by molding a carbon composite-based composition made primarily of graphite, a thermoset resin and a fibrous base material. As a result, such bipolar plates have an enhanced strength, but a poor flexibility.

### SUMMARY OF THE INVENTION

It is therefore an object of the invention to provide fuel cell bipolar plates which, even when given a thin-walled construction, are endowed with sufficient strength and excellent flexibility.

We have discovered that fuel cell bipolar plates obtained by compression molding, injection molding, transfer molding or otherwise molding a composition containing a porous artificial graphite material, a thermoset resin and an internal release agent in specific proportions have much better mechanical characteristics, including flexural strength and flexural strain, than prior-art fuel cell bipolar plates and thus, even when made thinner, have sufficient strength and excellent flexibility.

Accordingly, the invention provides a fuel cell bipolar plate obtained by molding a composition which includes 100 parts by weight of a porous artificial graphite material, 15 to 30 parts by weight of a thermoset resin, and 0.1 to 1.0 part by weight of an internal release agent.

Preferably, the fuel cell bipolar plate has a thickness at a thinnest wall portion thereof in a range of 0.15 to 0.3 mm.

The fuel cell bipolar plate typically has a flexural strength of 60 to 100 MPa and a flexural strain of 0.7 to 1.2%.

It is advantageous for the porous artificial graphite material to have a degree of graphitization of 65 to 85% and a true density of 1.6 to 2.1 g/ml.

Typically, the porous artificial graphite material has an average particle diameter of 20 to 200 μm, with preferably up to 1% of the particles having a size of up to 1 μm and up to 1% of the particles having a size of at least 300 μm.

The thermoset resin may be at least one selected from the group consisting of phenolic resins, epoxy resins, unsaturated polyester resins, melamine resins, urea resins, diallyl phthalate resins and bismaleimide resins.

The internal release agent may be at least one selected from the group consisting of metallic soaps and long-chain fatty acids.

The molding technique used to manufacture the fuel cell bipolar plate is preferably compression molding, injection molding or transfer molding.

The fuel cell bipolar plate of the invention, because it is obtained by molding a composition containing a porous artificial graphite material having excellent compatibility with resins, readily absorbs shock, has a sufficient strength even when given a thin-walled construction and is not easily damaged during removal from the mold and during stack assembly.

Moreover, because the inventive fuel cell bipolar plate also has an excellent flexibility, it does not readily incur damage in the course of automated transport during mass production and also has a good handleability.

Furthermore, the fuel cell bipolar plate of the invention exhibits a good gas impermeability even when it has been made thin-walled.

By using such fuel cell bipolar plates according to the invention, solid polymer fuel cells of a smaller size and thickness can easily be achieved.

### BRIEF DESCRIPTION OF THE DRAWINGS

FIG. 1A is a schematic sectional view of a fuel cell bipolar plate according to one embodiment of the invention.

FIG. 1B is a schematic sectional view of a fuel cell bipolar plate according to another embodiment of the invention.

### DESCRIPTION OF THE PREFERRED EMBODIMENTS

As noted above, the fuel cell bipolar plate of the invention is obtained by molding a composition which includes 100 parts by weight of a porous artificial graphite material, 15 to 30 parts by weight of a thermoset resin, and 0.1 to 1.0 part by weight of an internal release agent.

The porous artificial graphite material used in the inventive fuel cell bipolar plate has an average particle diameter, defined as the 50th percentile (referred to below as d50) in the grain size distribution, of preferably 20 to 200 μm, and more preferably 20 to 100 μm. At an average particle diameter of below 20 μm, the thermoset resin will readily coat the surface of the porous artificial graphite material, lowering the surface area of contact between particles of the porous artificial graphite, which may worsen the electrical conductivity of the bipolar plate itself. Conversely, at an average particle diameter above 200 μm, the surface area of contact between the porous artificial graphite particles and the thermoset resin is smaller, as a result of which a sufficient mechanical strength may not be achieved.

For the fuel cell bipolar plate to exhibit a sufficient strength even when it has a thin-walled construction, it is preferable for up to 1% of the particles in the porous artificial graphite material to have a diameter of up to 1 μm and up to 1% of the particles to have a diameter of at least 300 μm, and most preferable for up to 1% of the particles in the porous artificial graphite material to have a diameter of up to 3 μm and up to 1% of the particles to have a diameter of at least 250 μm.

“Average particle diameter” refers herein to a value measured using a Microtrak particle diameter analyzer.

Moreover, the porous artificial graphite material of the invention has a degree of graphitization of preferably 65 to 85%, and a true density of preferably 1.6 to 2.1 g/ml. At a degree of graphitization of less than 65% and a true density of less than 1.6 g/ml, there are too many graphite pores, which may lower the electrical conductivity. On the other hand, at a degree of graphitization of more than 85% and a true density of more than 2.1 g/ml, there are too few graphite pores, which may make it impossible to achieve a sufficient strength.

It is more preferable for the degree of graphitization to be from 70 to 85% and for the true density to be from 1.7 to 2.1 g/ml.

“Degree of graphitization,” as used herein, is an indicator of the degree to which a graphite structure having a stacking regularity in the carbonaceous material has developed. In the present invention, the degree of graphitization is measured by Raman spectroscopy.

“True density” refers herein to a measured value obtained by pycnometry.

The thermoset resin is not subject to any particular limitation. Use may be made of any of the various types of thermoset resins that are used to mold bipolar plates in the prior art. Illustrative examples include phenolic resins, epoxy resins, unsaturated polyester resins, urea resins, melamine resins, diallyl phthalate resins, bismaleimide resins and polycarbodiimide resins. Any one or combination of two or more of these may be used. Of these, the use of phenolic resins and epoxy resins are preferred because they have excellent heat resistances and mechanical strengths. If necessary, a curing accelerator may be used.

The internal release agent is not subject to any particular limitation. Use may be made of any of the various types of internal release agents used to mold bipolar plates in the prior art. Illustrative examples include metallic soaps such as zinc stearate, hydrocarbon-based synthetic waxes such as polyethylene waxes, and long-chain fatty acids such as stearic acid and carnauba wax. Any one or combination of two or more of these may be used.

In the practice of the invention, the porous artificial graphite material, the thermoset resin and the internal release agent are formulated in the following proportions: 100 parts by weight of the porous artificial graphite material, 15 to 30 parts by weight of the thermoset resin, and 0.1 to 1.0 parts by weight of the internal release agent. The amount of thermoset resin per 100 parts by weight of the porous artificial graphite material is preferably from 17 to 27 parts by weight, and more preferably from 20 to 24 parts by weight. The amount of the internal release agent per 100 parts by weight of the porous artificial graphite material is preferably from 0.2 to 0.7 part by weight, and more preferably from 0.3 to 0.5 part by weight.

At a thermoset resin content of less than 15 parts by weight, gaps tend to form between the particles of graphite powder, lowering the gas impermeability and strength. On the other hand, at a thermoset resin content of more than 30 parts by weight, the surface of the graphite powder becomes covered with the thermoset resin, lowering the electrical conductivity.

In the practice of the invention, other additives, such as short carbon fibers or short metal fibers, may be included in the fuel cell bipolar plate-forming composition, insofar as the physical properties of the molded body are not impaired.

The method of manufacturing the fuel cell bipolar plate of the invention involves mixing together the respective above ingredients to prepare a fuel cell bipolar plate-forming composition, then molding a body from this composition.

Any of various methods known to the art may be used without particular limitation to prepare the composition and to mold a body from the composition.

For example, preparation of the composition may be carried out by mixing, in any order and in the required proportions, the porous artificial graphite material, the thermoset resin and the internal release agent. Examples of mixers that may be used for this purpose include planetary mixers, ribbon blenders, Loedige mixers, Henschel mixers, rocking mixers and Nauta mixers.

The method of molding or otherwise forming the bipolar plate also is not subject to any particular limitation. For example, injection molding, transfer molding, compression molding or extrusion may be used.

With regard to the mold temperature, molding pressure and molding time during the molding operation, conditions known to the prior art may be used. For example, the following conditions may be employed: a mold temperature of about 150 to about 180° C., a molding pressure of about 20 to about 50 MPa, and a molding time of about 1 to about 5 minutes.

The fuel cell bipolar plate of the invention may be given a thin-walled construction in which the thinnest wall portion has a thickness of 0.15 to 0.3 mm, while yet achieving a high strength and high toughness characterized by a flexural strength of 60 to 100 MPa, a flexural modulus of 8 to 12 GPa, and a flexural strain of 0.7 to 1.2%.

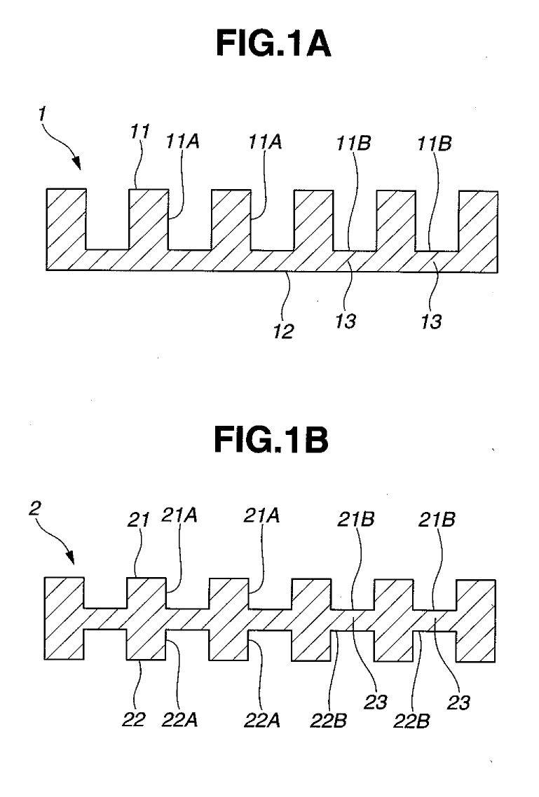

FIG. 1A shows a bipolar plate 1 of which gas flow channels 11A are formed on one side 11, which bipolar plate 1 has a thinnest wall portion 13 composed of a flow channel base 11B and a bipolar plate surface 12 on which flow channels are not formed. FIG. 1B shows a bipolar plate 2 of which relative gas flow channels 21A and 22A are formed on either side 21 and 22, which bipolar plate 2 has a thinnest portion 23 composed of the respective flow channel bases 21B and 22B which are mutually opposed.

Fuel cell bipolar plates having the above characteristics may be most suitably used as bipolar plates for solid polymer fuel cells. A solid polymer fuel cell is generally composed of a stack of many unit cells, each of which is constructed of a solid polymer membrane disposed between a pair of electrodes that are in turn sandwiched between a pair of bipolar plates which form channels for the supply and removal of gases. The fuel cell bipolar plate of the invention can be used as some or all of the plurality of bipolar plates in the fuel cell.

### EXAMPLES

The following Examples and Comparative Examples are provided by way of illustration and not by way of limitation. The following methods were used to measure average particle diameter, true density and degree of graphitization.

1. Average Particle Diameter

Measured using a Microtrak particle diameter analyzer.

2. True Density

Measured by pycnometry.

3. Degree of Graphitization

Measured by Raman spectroscopy.

### Example 1

One hundred parts by weight of Porous Artificial Graphite Material 1 (average particle diameter at d50 in grain size distribution, 30 μm; degree of graphitization, 80%; true density, 1.7 g/ml), 16 parts by weight of epoxy resin as a thermoset resin, 8 parts by weight of phenolic resin as a thermoset resin, 0.2 part by weight of triphenylphosphine as a curing accelerator, and 1 part by weight of an internal release agent (carnauba wax) were charged into a Henschel mixer and mixed at 1,500 rpm for 3 minutes, thereby preparing a fuel cell bipolar plate-forming composition.

Four grams of the resulting composition were charged into a 100×100 mm mold and compression molded at a mold temperature of 180° C. and a molding pressure of 29.4 MPa for a molding time of 2 minutes, thereby obtaining a fuel cell bipolar plate 1 having a thickness in the thinnest wall portion 13 of 0.15 mm, as shown in FIG. 1.

### Example 2

Aside from using 100 parts by weight of Porous Artificial Graphite Material 1, 24 parts by weight of phenolic resin as the thermoset resin and 1 part by weight of an internal release agent (carnauba wax), a fuel cell bipolar plate-forming composition and a fuel cell bipolar plate were obtained in the same way as in Example 1.

### Example 3

Aside from using Porous Artificial Graphite Material 2 (average particle diameter at d50 in grain size distribution, 40 μm; degree of graphitization, 80%; true density, 1.7 g/ml) instead of Porous Artificial Graphite Material 1, a fuel cell bipolar plate was obtained in the same way as in Example 1.

### Example 4

Aside from using Porous Artificial Graphite Material 2 instead of Porous Artificial Graphite Material 1, a fuel cell bipolar plate was obtained in the same way as in Example 2.

### Example 5

Aside from using Porous Artificial Graphite Material 3 (average particle diameter at d50 in grain size distribution, 30 μm; degree of graphitization, 80%; true density, 2.1 g/ml) instead of Porous Artificial Graphite Material 1, a fuel cell bipolar plate was obtained in the same way as in Example 1.

### Example 6

Aside from using Porous Artificial Graphite Material 3 instead of Porous Artificial Graphite Material 1, a fuel cell bipolar plate was obtained in the same way as in Example 2.

### Comparative Example 1

Aside from using needle-like artificial graphite (average particle diameter, 60 μm; degree of graphitization, 100%) instead of Porous Artificial Graphite Material 1, a fuel cell bipolar plate was obtained in the same way as in Example 1.

### Comparative Example 2

Aside from using the same needle-like artificial graphite as in Comparative Example 1 instead of Porous Artificial Graphite Material 1, a fuel cell bipolar plate was obtained in the same way as in Example 2.

### Comparative Example 3

Aside from using natural graphite (average particle diameter, 30 μm; degree of graphitization, 100%) instead of Porous Artificial Graphite Material 1, a fuel cell bipolar plate was obtained in the same way as in Example 1.

### Comparative Example 4

Aside from using the same natural graphite as in Comparative Example 3 instead of Porous Artificial Graphite Material 1, a fuel cell bipolar plate was obtained in the same way as in Example 2.

The fuel cell bipolar plates obtained in the respective above examples of the invention and comparative examples were measured and evaluated for resistivity, flexural strength, flexural modulus and flexural strain. The results are presented in Table 1.

TABLE 1

| | | Graphite material | | | | | | | |
|---|---|---|---|---|---|---|---|---|---|
| | | | Average | | | Fuel cell bipolar plate | | | |
| | | | particle | Degree of | True | | Flexural | Flexural | Flexural |
| | | | diameter | graphiti- | density | Resistivity | strength | modulus | strain |
| | | Type | (μm) | zation (%) | (g/ml) | (mΩ · cm) | (MPa) | (GPa) | (%) |
| Example | 1 | Porous Artificial | 30 | 80 | 1.7 | 15 | 90 | 9 | 1.0 |
| | | Graphite 1 | | | | | | | |
| | 2 | Porous Artificial | 30 | 80 | 1.7 | 14 | 90 | 10 | 1.0 |
| | | Graphite 1 | | | | | | | |
| | 3 | Porous Artificial | 40 | 80 | 1.7 | 15 | 75 | 11 | 0.8 |
| | | Graphite 2 | | | | | | | |
| | 4 | Porous Artificial | 40 | 80 | 1.7 | 14 | 75 | 12 | 0.8 |
| | | Graphite 2 | | | | | | | |
| | 5 | Porous Artificial | 30 | 80 | 2.1 | 10 | 80 | 8 | 0.9 |
| | | Graphite 3 | | | | | | | |
| | 6 | Porous Artificial | 30 | 80 | 2.1 | 8 | 80 | 10 | 0.9 |
| | | Graphite 3 | | | | | | | |
| Compar- | 1 | Needle-like | 60 | 100 | — | 15 | 55 | 16 | 0.5 |
| ative | | artificial graphite | | | | | | | |
| Example | 2 | Needle-like | 60 | 100 | — | 13 | 52 | 18 | 0.4 |
| | | artificial graphite | | | | | | | |
| | 3 | Natural graphite | 30 | 100 | — | 12 | 53 | 18 | 0.4 |
| | 4 | Natural graphite | 30 | 100 | — | 10 | 55 | 20 | 0.4 |

The properties in Table 1 were measured using the following methods.

1. Resistivity

Measured based on JIS H0602 (Method for Measuring Resistivity of Silicon Single Crystal and Silicon Wafer Using a Four-Point Probe.

2. Flexural Strength, Flexural Modulus, Flexural Strain

Measured based on ASTM D790 (Standard Test Methods for Flexural Properties of Unreinforced and Reinforced Plastics and Electrical Insulating Materials)

As is apparent from the results in Table 1, the flexural strengths of the fuel cell bipolar plates in Examples 1 to 6 according to the invention were about 1.5 to 2 times higher than those in Comparative Examples 1 to 4. Moreover, each of the fuel cell bipolar plates in Examples 1 to 6 had a flexural modulus that was about 0.5 to 0.75 times as large as those in Comparative Examples 1 to 4, indicating that they had excellent flexibilities. In addition, the flexural strains of the fuel cell bipolar plates of Examples 1 to 6 were about twice as large as the results obtained for the fuel cell bipolar plates in Comparative Examples 1 to 4, demonstrating the excellent flexibility of the former.

Japanese Patent Application No. 2005-327627 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A fuel cell bipolar plate obtained by molding a composition comprising 100 parts by weight of a porous artificial graphite material, 15 to 30 parts by weight of a thermoset resin, and 0.1 to 1.0 part by weight of an internal release agent.

2. The fuel cell bipolar plate of claim 1 which has a thickness at a thinnest wall portion thereof in a range of 0.15 to 0.3 mm.

3. The fuel cell bipolar plate of claim 1 which has a flexural strength of 60 to 100 MPa and a flexural strain of 0.7 to 1.2%.

4. The fuel cell bipolar plate of claim 1, wherein the porous artificial graphite material has a degree of graphitization of 65 to 85% and a true density of 1.6 to 2.1 g/ml.

5. The fuel cell bipolar plate of claim 1, wherein the porous artificial graphite material has an average particle diameter of 20 to 200 μm.

6. The fuel cell bipolar plate of claim 5, wherein up to 1% of the particles in the porous artificial graphite material have a diameter of up to 1 μm and up to 1% of the particles have a diameter of at least 300 μm.

7. The fuel cell bipolar plate of claim 1, wherein the thermoset resin is at least one selected from the group consisting of phenolic resins, epoxy resins, unsaturated polyester resins, melamine resins, urea resins, diallyl phthalate resins and bismaleimide resins.

8. The fuel cell bipolar plate of claim 1, wherein the internal release agent is at least one selected from the group consisting of metallic soaps and long-chain fatty acids.

9. The fuel cell bipolar plate of claim 1, wherein molding is carried out by compression molding, injection molding or transfer molding.
